(19) United States
(12) Patent Application Publication
(10) Pub. No.: US 2025/0225941 A1
(43) Pub. Date: Jul. 10, 2025

(54) DISPLAY DRIVER, DISPLAY PANEL, AND IMAGE DISPLAY DRIVING METHOD

(71) Applicant: Huawei Technologies Co., Ltd., Shenzhen (CN)

(72) Inventors: Li Zhang, Shanghai (CN); Haohui Long, Beijing (CN); Xiaoyu Li, Shanghai (CN)

(21) Appl. No.: 19/093,787

(22) Filed: Mar. 28, 2025

Related U.S. Application Data
(63) Continuation of application No. PCT/CN2023/127541, filed on Oct. 30, 2023.

(30) Foreign Application Priority Data
Nov. 29, 2022 (CN) 202211513969.X

(51) Int. Cl. G09G 3/3266

(52) U.S. Cl. CPC G09G 3/3266; G09G 2300/0842; G09G 2310/08; G09G 2330/021

(57) ABSTRACT

In accordance with an embodiment, a display driver is configured to drive pixel units arranged in an array on a display panel that includes a first display area and a second display area to perform image display operations. In response to both the first display area and the second display area performing the image display operations, a time sequence control circuit in the display driver continuously outputs a scanning-related signal, a data-related signal, and a light-emitting-related signal in first duration and second duration. In response to the first display area performing the image display operations and the second display area stopping performing the image display operations, the time sequence control circuit stops outputting the scanning-related signal, the data-related signal, and the light-emitting-related signal in the second duration.

### CROSS-REFERENCE TO RELATED APPLICATIONS

This application is a continuation of International Application No. PCT/CN2023/127541, filed on Oct. 30, 2023, which claims priority to Chinese Patent Application No. 202211513969.X, filed on Nov. 29, 2022. The disclosures of the aforementioned applications are hereby incorporated by reference in their entireties.

### TECHNICAL FIELD

This application relates to the field of display technologies, and in particular, to a display driver, a display panel, and an image display driving method.

### BACKGROUND

With development of display technologies, sizes of displays of display devices of mobile devices, such as a tablet computer or a mobile phone, have a significant impact on a display effect. To make an image to be displayed clearer and more vivid, a size of a display of a tablet computer or a mobile phone is increasingly larger. However, the tablet computer or the mobile phone with a large-size screen is less portable. To resolve the foregoing problem, a bendable flexible display is proposed. A user can bend the display as needed, to improve portability of a mobile phone. However, reducing power consumption of a display device after a flexible display is folded becomes an urgent problem to be resolved.

### SUMMARY

Embodiments of the present invention provide a display driver and a display panel, to reduce power consumption when the display driver performs image display, and further provide a method for driving the display driver to perform image display.

According to a first aspect, an embodiment of the present invention provides a display driver. The display driver is configured to drive pixel units arranged in an array on a display panel that includes a first display area and a second display area to perform image display.

The display driver includes a time sequence control circuit, configured to output a scanning-related signal, a data-related signal, and a light-emitting-related signal. The scanning-related signal, the light-emitting-related signal, and the data-related signal are respectively used to drive a scanning drive circuit in the display panel to output a scan signal, drive a light-emitting drive circuit in the display panel to output a light-emitting signal, and drive a data drive circuit to output a data signal to a plurality of pixel units. The scan signal, the light-emitting signal, and the data signal cooperate to drive the pixel unit to perform image display.

When both the first display area and the second display area perform image display, the time sequence control circuit continuously outputs the scanning-related signal, the data-related signal, and the light-emitting-related signal in first duration and second duration.

When the first display area performs image display and the second display area stops image display, the time sequence control circuit stops outputting the scanning-related signal, the data-related signal, and the light-emitting-related signal in the second duration.

When only some display areas of the display panel perform image display, for example, when the second display area is folded and does not need to perform image display, and when the second display area does not perform image display in a display time period of a frame of image, the display driver stops outputting a scan clock signal, a light-emitting clock signal, a data clock signal, the data signal, a scan trigger signal, and a light-emitting trigger signal, so that power consumption of the display driver is effectively reduced.

In an embodiment of this application, the scanning-related signal includes a scan clock signal, a scan trigger signal, and a reset signal. The light-emitting-related signal includes a light-emitting clock signal and a light-emitting trigger signal. The data-related signals include a data clock signal and the data signal.

The scan clock signal and the scan trigger signal are used to drive the scanning drive circuit to output the scan signal. The light-emitting clock signal and the light-emitting trigger signal are used to drive the light-emitting drive circuit to output the light-emitting signal. The data clock signal is used to drive the data drive circuit to output the data signal.

In an embodiment of this application, the scanning-related signal may further include a reset signal, a reset clock signal, and a reference voltage signal.

In an embodiment of this application, the display driver further includes a storage unit. The storage unit is configured to store the first duration and the second duration. The first duration is duration in which a pixel unit in the first display area performs image display in display duration of a frame of image. The second duration is duration in which a pixel unit in the second display area performs image display.

In an embodiment of this application, the display driver further includes a detection circuit, and the detection circuit is configured to detect a relative location relationship between the first display area and the second display area.

When the first display area and the second display area are located in a same display plane, both the first display area and the second display area perform image display, and the detection circuit outputs a first detection signal, where the first detection signal is used to control the time sequence control unit to continuously output the scanning-related signal, the data-related signal, and the light-emitting-related signal.

When the first display area and the second display area are located in different planes, the first display area performs image display, the second display area does not perform image display, and the detection circuit outputs a second detection signal to the time sequence control circuit, where the second detection signal is used to control the time sequence control circuit to stop outputting the scanning-related signal, the data-related signal, and the light-emitting-related signal in the second duration.

In an embodiment of this application, the display panel includes a plurality of pixel units arranged in an n*m array, where the first display area includes pixel units in a first row to an i^{th} row, and the second display area includes pixel units in an (i+1)^{th} row to an n^{th} row, where i is a positive integer greater than or equal to 1 and less than n. The first duration corresponds to duration in which the pixel units in the first row to the i^{th} row receive the data signal. The second duration corresponds to duration in which the pixel units in the (i+1)^{th} row to the n^{th} row receive the data signal.

In an embodiment of this application, the display driver further includes a timing circuit. The timing circuit is connected to the detection circuit. When the first display area and the second display area are located in the different planes, the timing circuit receives the first detection signal from the detection circuit, performs timing on the first duration in which the pixel units in the first row to the i^{th} row receive the data signal, and performs timing on the duration in which the pixel units in the (i+1)^{th} row to the n^{th} row receive the data signal.

A first timing signal is output to the time sequence control circuit when timing on the first duration is completed, and the time sequence control circuit stops outputting the scanning-related signal, the data-related signal, and the light-emitting-related signal after receiving the first timing signal.

A second timing signal is output to the time sequence control circuit when timing on the second duration is completed, and the time sequence control circuit outputs, for the first display area, the scanning-related signal, the data-related signal, and the light-emitting-related signal in display duration of a frame of image after receiving the second timing signal.

According to a second aspect, an embodiment of this application provides a display panel including the display driver. The display panel further includes a display area and a non-display area. The display area includes n scan lines extending in a first direction, n light-emitting lines extending in the first direction, and m data lines extending in a second direction. A plurality of pixel areas are formed at a location of intersection between the n scan lines and the m data lines. A plurality of pixel units are respectively correspondingly located in the pixel areas. Each pixel unit is connected to the scan lines, the light-emitting lines, and the data lines. The scanning drive circuit and the light-emitting drive circuit are disposed in the non-display area. The scanning drive circuit is connected to the n scan lines. The light-emitting drive circuit is connected to the n light-emitting lines. The display driver is connected to the scanning drive circuit, the light-emitting drive circuit, and the m data lines extending in the second direction, to respectively provide the scan clock signal, the light-emitting clock signal, the data clock signal, the data signal, the scan trigger signal, and the light-emitting trigger signal.

When stopping image display in the second display area of the display panel, the display driver stops outputting a plurality of signals, so that power consumption of the display panel is effectively reduced.

In an embodiment of this application, the first display area includes pixel units correspondingly connected to a first scan line to an i^{th} scan line. The second display area includes pixel units correspondingly connected to an (i+1)^{th} scan line to an n^{th} scan line.

The scanning drive circuit is configured to output a scan signal based on the scan clock signal and the scan trigger signal, and the scanning drive circuit is connected to the first scan line to the n^{th} scan line and is configured to sequentially output a plurality of scan signals. The first duration is duration in which the first scan line to the n^{th} scan line output the plurality of the scan signals. The second duration is duration in which the (i+1)^{th} scan line to the n^{th} scan line output the plurality of the scan signals.

The light-emitting drive circuit is configured to output a light-emitting signal based on the light-emitting clock signal and the light-emitting trigger signal, and the light-emitting drive circuit is connected to a first light-emitting line to an n^{th} light-emitting line and is configured to sequentially output a plurality of light-emitting signals.

According to a third aspect, an embodiment of this application provides an image display driving method, applied to a display driver. The display driver is configured to drive pixel units arranged in an array on a display panel to perform image display. The display panel includes a first display area and a second display area. The method includes:
when both the first display area and the second display area perform image display, continuously outputting a scanning-related signal, a data-related signal, and a light-emitting-related signal in first duration and second duration; or
when the first display area performs image display and the second display area stops image display, stopping outputting the scanning-related signal, the data-related signal, and the light-emitting-related signal in the second duration, where
the scanning-related signal, the light-emitting-related signal, and the data-related signal are respectively used to drive a scanning drive circuit in the display panel to output a scan signal, drive a light-emitting drive circuit in the display panel to output a light-emitting signal, and drive a data drive circuit to output a data signal to a plurality of pixel units, the scan signal, the light-emitting signal, and the data signal cooperate to drive the pixel unit to perform image display, the first duration is duration in which a pixel unit in the first display area performs image display in display duration of a frame of image, and the second duration is second duration in which a pixel unit in the second display area performs image display.

In an embodiment of this application, the outputting a scanning-related signal, a data-related signal, and a light-emitting-related signal includes: controlling a time sequence control circuit to output the scanning-related signal, the data-related signal, and the light-emitting-related signal, where the scanning-related signal includes a scan clock signal, a scan trigger signal, and a reset signal; the light-emitting-related signal includes a light-emitting clock signal and a light-emitting trigger signal; and the data-related signal includes a data clock signal and the data signal, where the scan clock signal and the scan trigger signal are used to drive the scanning drive circuit to output the scan signal, the light-emitting clock signal and the light-emitting trigger signal are used to drive the light-emitting drive circuit to output the light-emitting signal, and the data clock signal is used to drive the data drive circuit to output the data signal; and
after the time sequence control circuit outputs the data-related signal, controlling the data drive circuit to output the data signal to a plurality of data lines based on the data clock signal.

In an embodiment of this application, the image display driving method further includes:
detecting a location relationship between the first display area and the second display area;
when the first display area and the second display area are located in a same display plane, outputting a first detection signal to the time sequence control circuit, where the first detection signal is used to control the time sequence control unit to continuously output the scanning-related signal, the data-related signal, and the light-emitting-related signal; or
when the first display area and the second display area are located in different display planes, outputting a second detection signal to the time sequence control circuit, where the second detection signal is used to control the time sequence control circuit to stop outputting the scanning-related signal, the data-related signal, and the light-emitting-related signal in the second duration.

In an embodiment of this application, controlling a timing circuit to perform timing on the first duration and the second duration specifically includes:
when the second detection signal is received, performing timing on the first duration in which pixel units in a first row to an i^{th} row receive the data signal, and performing timing on duration in which pixel units in an (i+1)^{th} row to an n^{th} row receive the data signal;
outputting a first timing signal to the time sequence control circuit when timing on the first duration is completed, and stopping, by the time sequence control circuit, outputting the scanning-related signal, the data-related signal, and the light-emitting-related signal after receiving the first timing signal; and
outputting a second timing signal to the time sequence control circuit when timing on the second duration is completed, and outputting, by the time sequence control circuit for the first display area, the scanning-related signal, the data-related signal, and the light-emitting-related signal in display duration of a frame of image after receiving the first timing signal.

In an embodiment of this application, the image display driving method further includes: storing the first duration and the second duration in a storage unit in advance, where in an embodiment of this application, the display panel includes a display area and a non-display area, the display area includes n scan lines extending in a first direction, n light-emitting lines extending in the first direction, and m data lines extending in a second direction, the first display area includes pixel units correspondingly connected to a first scan line to an i^{th} scan line, the second display area includes pixel units correspondingly connected to an (i+1)^{th} scan line to an n^{th} scan line, the first duration is duration in which the first scan line to the i^{th} scan line output a plurality of scan signals, and the second duration is duration in which the (i+1)^{th} scan line to the n^{th} scan lines output a plurality of scan signals; and
disposing the scanning drive circuit and the light-emitting drive circuit in the non-display area, where the scanning drive circuit is connected to the n scan lines, and the light-emitting drive circuit is connected to the n light-emitting lines.

### BRIEF DESCRIPTION OF THE DRAWINGS

FIG. 1 is a diagram of a structure of a display apparatus according to some embodiments of this application;

FIG. 2 is a side view of a structure of a display terminal in FIG. 1;

FIG. 3 is a diagram of a plane layout of an array substrate on the display panel shown in FIG. 2;

FIG. 4 is a diagram of a circuit structure of a pixel unit in FIG. 3;

FIG. 5 is a diagram of a driving time sequence of the pixel unit shown in FIG. 4;

FIG. 6 and FIG. 7 are diagrams of structures of a display terminal shown in FIG. 1 in a folded state and an unfolded state;

FIG. 8 is a connection diagram of a circuit for a display driver shown in FIG. 3;

FIG. 9 is a diagram of a circuit structure of the display driver shown in FIG. 8;

FIG. 10 is a flowchart of an image display driving method of a display apparatus shown in FIG. 3 to FIG. 6; and

FIG. 11 and FIG. 12 each are a diagram of driving of a first display area and a second display area of a display panel shown in FIG. 6 and FIG. 7.

### DETAILED DESCRIPTION OF ILLUSTRATIVE EMBODIMENTS

To make the objectives, technical solutions, and advantages of this application clearer, the following further describes this application in detail with reference to the accompanying drawings.

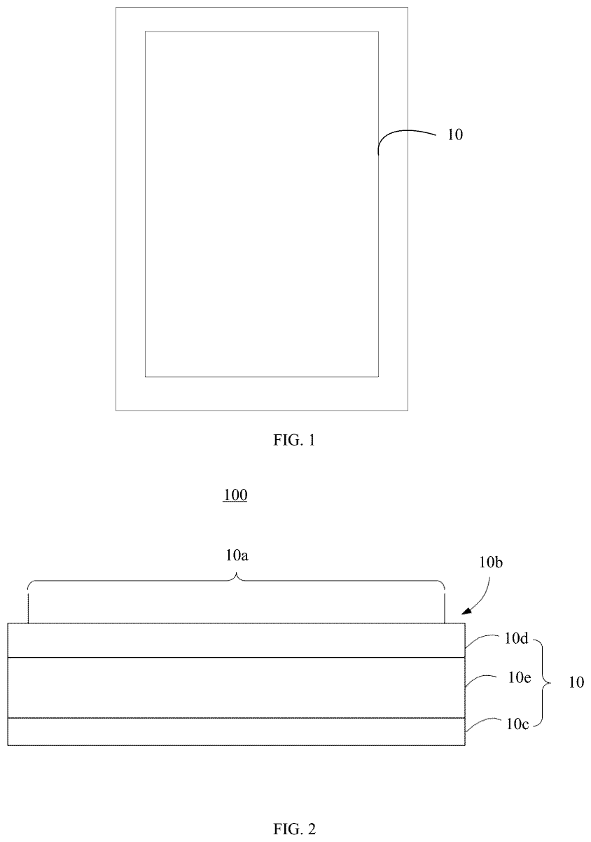

FIG. 1 is a diagram of a structure of a display apparatus 100 according to a first embodiment of this application.

The display apparatus 100 includes a display panel 10. In this embodiment of this application, the display apparatus 100 may alternatively be a mobile terminal. The mobile terminal includes, for example, a mobile phone, a tablet computer, a personal digital assistant (PDA), and an in-vehicle computer. A specific form of the mobile terminal is not specifically limited in embodiments of this application.

FIG. 2 is a side view of a structure of the display apparatus 100 in FIG. 1.

As shown in FIG. 2, the display panel 10 includes a display area (Active Area, AA) 10a and a non-display area (NA) 10b of an image. The display area 10a is used to perform image display. The non-display area 10b is arranged around the display area 10a to dispose another auxiliary component or module. Specifically, the display panel 10 includes an array substrate 10c, an opposite substrate 10d, and a display medium layer 10e sandwiched between the array substrate 10c and the opposite substrate 10d. In this embodiment, a display medium in the display medium layer 10e is a light-emitting semiconductor material such as a Micro LED, a Mini LED, or an LED.

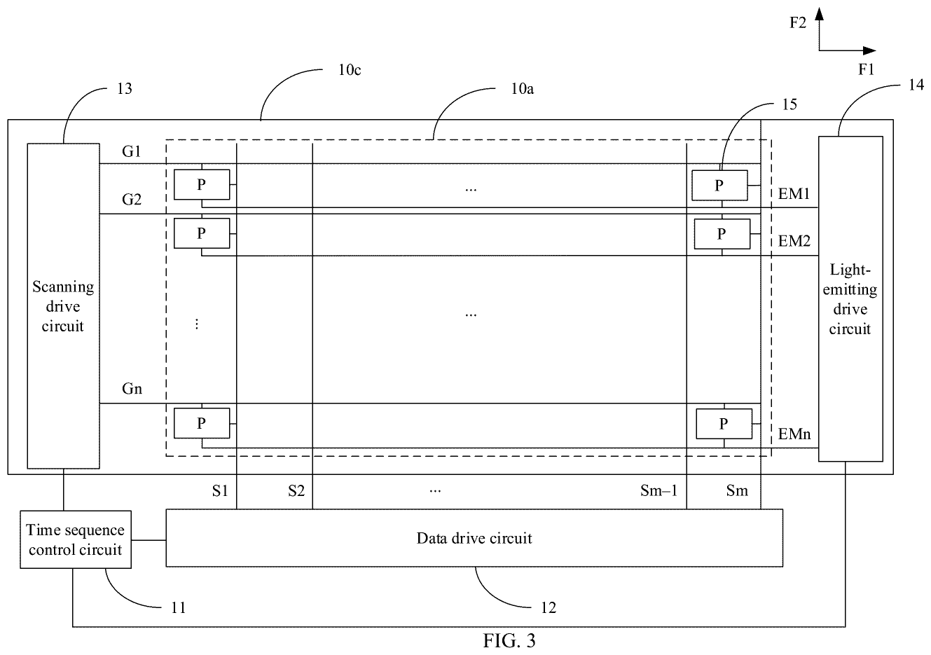

FIG. 3 is a diagram of a plane layout of the array substrate 10c on the display panel 10 shown in FIG. 2.

As shown in FIG. 3, the corresponding image display area 10a in the array substrate 10c includes a plurality of pixel units 15 arranged in an n*m matrix, m data lines Si to Sm, n scan lines G1 to Gn, and n light-emitting control lines EM1 to EMn, where m and n are a natural number greater than 1.

The n scan lines G1 to Gn and the n light-emitting control lines EM1 to EMn extend in a first direction F1, and are insulated from each other and arranged in parallel in a second direction F2. The m data lines Si to Sm extend in the second direction F2, and are insulated from each other and arranged in parallel in the first direction F1. The first direction F1 and the second direction F2 are perpendicular to each other. In this embodiment, n may be 3000.

In the corresponding non-display area 10b (shown in FIG. 2) of the display panel 10, the display apparatus 100 further includes a time sequence control circuit 11 configured to drive a pixel unit to perform image display, a data drive circuit 12, and a scanning drive circuit 13 and a light-emitting drive circuit 14 that are disposed on the array substrate 10c.

The time sequence control circuit 11 is electrically connected to the data drive circuit 12, the scanning drive circuit 13, and the light-emitting drive circuit 14, to control working time sequences of the data drive circuit 12, the scanning drive circuit 13, and the light-emitting drive circuit 14, in other words, output a corresponding time sequence signal to the data drive circuit 12 and the scanning drive circuit 13, to control time at which a corresponding scan signal, a corresponding light-emitting signal, and a corresponding data signal are output.

The data drive circuit 12 is electrically connected to the m data lines Si to Sm, to transmit, through the m data lines Si to Sm, a to-be-displayed data signal (Data) to the plurality of pixel units 15 in a form of a data voltage.

The scanning drive circuit 13 is configured to electrically connect to the n scan lines G1 to Gn. The scanning drive circuit 13 outputs, through the n scan lines G1 to Gn, a scan signal to control time at which the pixel unit 15 receive a data signal. The scanning drive circuit 13 outputs scan signals through scanning lines G1, G2, . . . , Gn in sequence based on a location arrangement order and a scanning periodicity.

The light-emitting drive circuit 14 is configured to: after the pixel unit 15 receives the data signal and the scan signal, output a light-emitting signal through the light-emitting control lines EM1, EM2, . . . , and EMn at a preset moment to control the pixel unit 15 to emit light for image display.

In this embodiment, a circuit element in the scanning drive circuit 13 is manufactured in the array substrate 10c in a same process as the pixel units 15 in the array substrate 10c, which is also known as a GOA (Gate Driver on Array) technology.

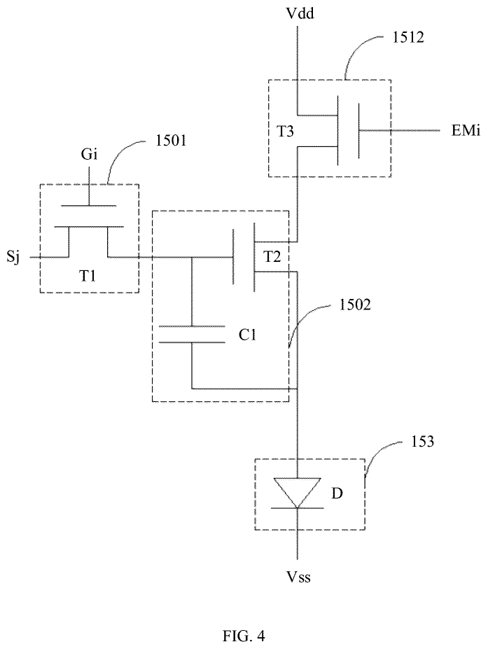

FIG. 4 is a diagram of a circuit structure of the pixel unit 15 in FIG. 3.

As shown in FIG. 4, a signal receiving unit 1501 includes a first switching transistor T1, a gate of the first switching transistor T1 is connected to an i^{th} scan line Gi, a source of the first switching transistor T1 is connected to a j^{th} data line Sj, a drain of the first switching transistor T1 is connected to a drive unit 1502, and the first switching transistor T1 is configured to receive a scan signal from the i^{th} scan line Gi and is conducted under control of the scan signal, so that a data signal output by the j^{th} data line Sj is transmitted to the drive unit 1502 by using the first switching transistor T1, where i is a positive integer greater than or equal to 1 and less than n, and j is a positive integer greater than or equal to 1 and less than m.

The drive unit 1502 includes a second switching transistor T2 and a first capacitor C1. A gate of the second switching transistor T2 is connected to the drain of the first switching transistor T1, and is configured to receive a data signal transmitted by the first switching transistor T1. A source of the second switching transistor T2 is connected to a first conduction unit 1512. A drain of the second switching transistor T2 is connected to a light-emitting module 153. The first capacitor C1 is connected between the gate and the drain of the second switching transistor T2, and is configured to receive a data signal for charging, and maintain a conduction state of the second switching transistor T2 when the second switching transistor T2 is conducted. When the second switching transistor T2 is conducted, the first conduction unit 1512 is electrically connected to the light-emitting module 153.

The first conduction unit 1512 includes a third switching transistor T3. A gate of the third switching transistor T3 is connected to a light-emitting line EMi, and is configured to receive a light-emitting signal through the light-emitting line EMi. A source of the third switching transistor T3 is connected to a power supply voltage Vdd. A drain of the third switching transistor T3 is connected to the source of the second switching transistor T2. The third switching transistor T3 is configured to be conducted under control of the light-emitting signal, so that the power supply voltage Vdd is transmitted to the source of the second switching transistor T2 by using the third switching transistor T3.

The light-emitting signal is transmitted to the gate of the third switching transistor T3, to control a voltage of the gate of the third switching transistor T3 to rise to a conducted voltage, so that the third switching transistor T3 is driven to be conducted.

The light-emitting module 153 includes at least one light-emitting element D. An anode of the light-emitting element D is electrically connected to the drain of the second switching transistor T2, and a cathode of the light-emitting element D is electrically connected to a low-voltage end Vss. The light-emitting element is configured to receive, from the second switching transistor T2, a drive current provided by the power supply voltage Vdd, and the drive current drives the light-emitting element D to emit light.

It may be understood that the light-emitting element D is an organic light-emitting diode (OLED). In addition, in another embodiment of this application, the pixel unit 15 may further include more switching transistors, capacitors, and resistance elements, which is not limited thereto. For example, the pixel unit 15 may include seven thin film transistors (TFT) and two capacitors (C) to cooperate to drive the light-emitting element D to emit light and perform image display. In addition, the switching transistor may be a P-type thin film transistor (TFT) or an N-type thin film transistor.

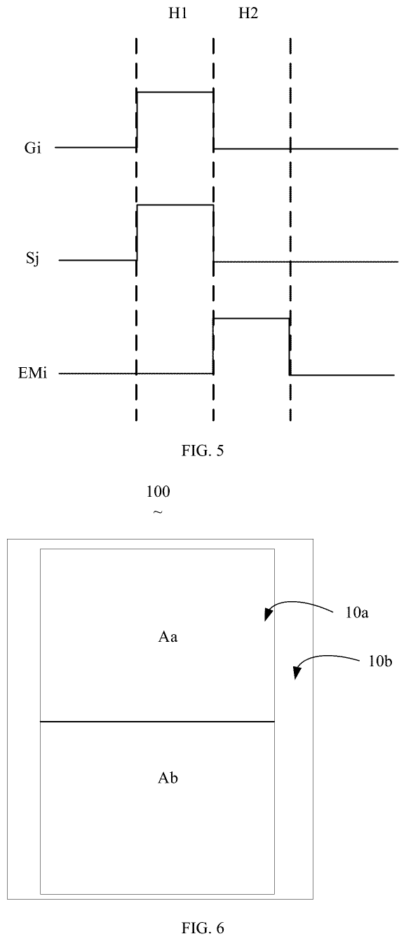

Refer to FIG. 3 to FIG. 5. FIG. 5 is a diagram of a driving time sequence of the pixel unit 15 shown in FIG. 4.

In a display time period of a frame of image, a working process of the pixel unit 15 includes two consecutive stages in time: a data writing stage H1 and a light-emitting stage H2.

In the data writing stage H1, under control of a scan signal Gi, the first switching transistor T1 is conducted, the source and the drain of the first switching transistor T1 are electrically conducted, and a data signal (Data) is written into the first capacitor C1 and is also loaded to the gate of the second switching transistor T2.

In the light-emitting stage H2, the second switching transistor T2 is conducted under driving of a data signal, and the third switching transistor T3 is conducted under control of the light-emitting control signal EMi. After the third switching transistor T3 is conducted, the voltage VDD transmits a drive current to the light-emitting element D by using the third switching transistor T3 and the second switching transistor T2, to drive the OLED to emit light.

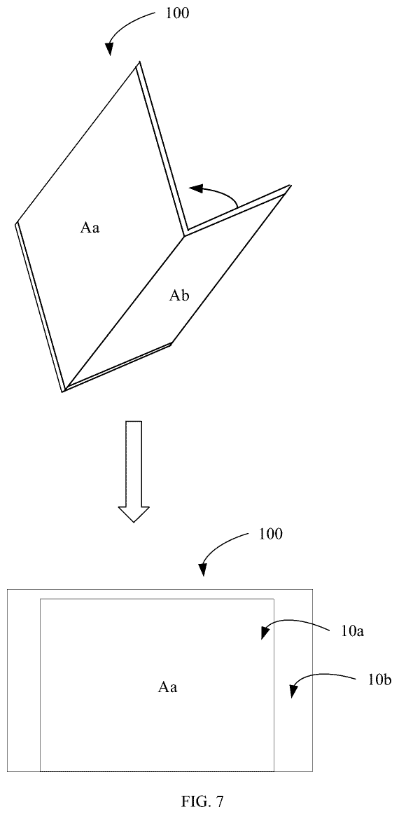

When the display apparatus 100 is a foldable display terminal, in some embodiments of this application, as shown in FIG. 6, the display area 10a of the display panel 10 may be divided into a plurality of display subareas, for example, a first display area Aa and a second display area Ab. When the display apparatus 100 is in an unfolded state, the first display area Aa and the second display area Ab are in a same display plane. When the display apparatus 100 is in a folded state, as shown in FIG. 7, the first display area Aa and the second display area Ab are in different planes, in other words, there is a specific angle between the first display area Aa and the second display area Ab. In this case, only the first display area Aa is in a display state, and the second display area Ab is in a non-display state, for example, a blank screen state. FIG. 6 and FIG. 7 are diagrams of structures of a display terminal shown in FIG. 1 in a folded state and an unfolded state.

Specifically, the first display area includes pixel units 15 in a first row to an i^{th} row, namely, pixel units 15 correspondingly connected to a first scan line to an i^{th} scan line.

The second display area includes pixel units 15 in an (i+1)^{th} row to an n^{th} row, namely, pixel units 15 correspondingly connected to an (i+1)^{th} scan line to an n^{th} scan line. In this embodiment, i is half of n, for example, 1500.

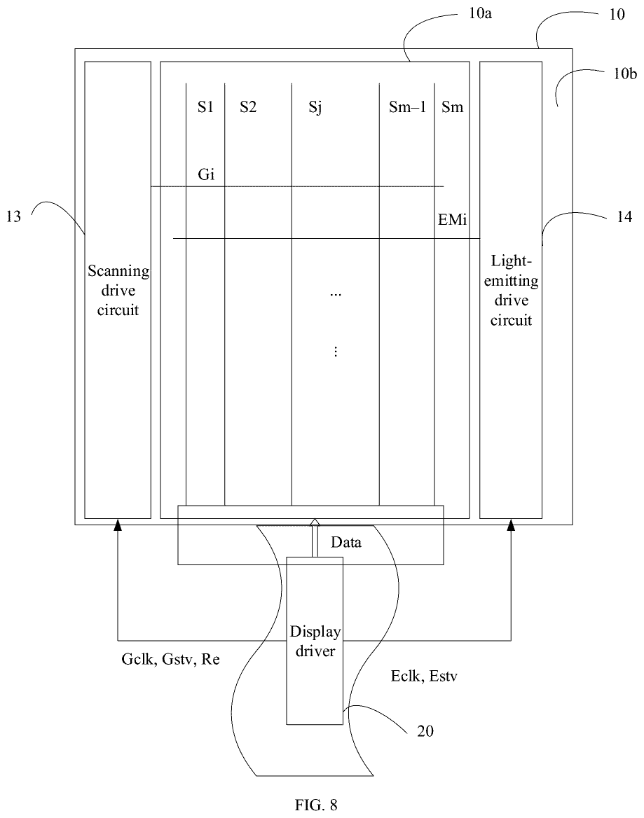

FIG. 8 is a connection diagram of a circuit for a display driver shown in FIG. 3.

As shown in FIG. 8, the scanning drive circuit 13, the light-emitting drive circuit 14, and the m data lines that are disposed in the non-display area 10b are all connected to a display driver 20. In this embodiment, the display driver 20 is a display driver integrated circuit (DDIC). The time sequence control circuit 11 and the data drive circuit 12 shown in FIG. 3 are also disposed in the display driver 20. In this embodiment, the display driver 20 is disposed on a flexible circuit board (not shown), and the flexible circuit board is connected to a circuit corresponding to the display area 10a by using the non-display area 10b.

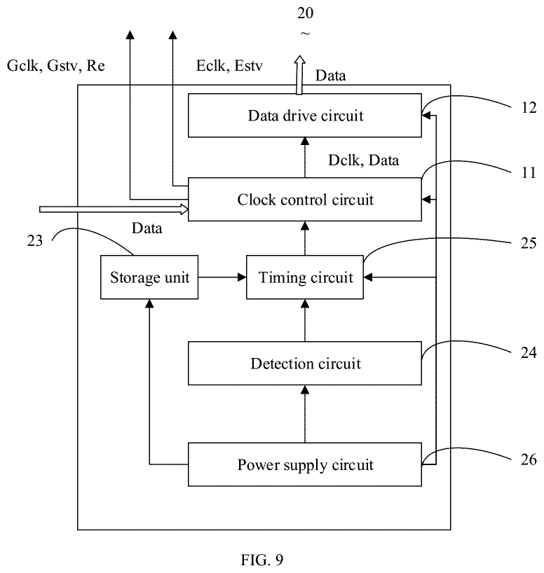

Specifically, FIG. 9 is a diagram of a circuit structure of the display driver 20 shown in FIG. 8.

The display driver 20 is configured to provide a scanning-related signal for the scanning drive circuit 13, and the scanning-related signal is used to drive the scanning drive circuit 13 to accurately output a plurality of scan signals to n scan lines. In this embodiment, the scanning-related signal includes a scan trigger signal Gstv and a clock signal Gclk.

The display driver 20 further provides a light-emitting-related signal for the light-emitting drive circuit 14, and the light-emitting-related signal is used to drive the light-emitting drive circuit 14 to accurately output a plurality of light-emitting signals to n light-emitting lines. In this embodiment, the light-emitting-related signal includes a light-emitting trigger signal Estv and a clock signal Eclk.

In addition, the display driver 20 provides a data-related signal for the data drive circuit 12. In this embodiment, the data-related signal includes a data clock signal (Dclk) and a data signal (Data). The data clock signal (Dclk) is used to control the data drive circuit 12 to transmit the data signal (Data) to a plurality of data lines Si to Sm.

More specifically, the display driver 20 includes the time sequence control circuit 11, the data drive circuit 12, a storage unit 23, a detection circuit 24, a timing circuit 25, and a power supply circuit 26.

As shown in FIG. 3, the time sequence control circuit 11 is configured to receive a to-be-displayed image signal from outside. The to-be-displayed image signal is a data signal (Data) existing in a form of a digital signal.

The time sequence control circuit 11 separately outputs corresponding signals to the scanning drive circuit 13, the light-emitting drive circuit 14, and the data drive circuit 12 based on the received data signal (Data), so as to drive and control the scanning drive circuit 13, the light-emitting drive circuit 14, and the data drive circuit 12 to output corresponding signals to the pixel unit 15, and drive the pixel unit 15 to perform image display based on the data signal (Data).

Specifically, the time sequence control circuit 11 outputs the scan clock signal Gclk and the scan trigger signal Gstv in the scanning-related signal to the scanning drive circuit 13, and outputs the light-emitting clock signal Eclk and the light-emitting trigger signal Estv in the light-emitting-related signal to the light-emitting drive circuit 14. It may be understood that the scan clock signal Gclk and the scan trigger signal Gstv are used to drive the scanning drive circuit 13 to output a scan signal, and the light-emitting clock signal Eclk and the light-emitting trigger signal Estv are used to drive the light-emitting drive circuit 14 to output a light-emitting signal.

Definitely, the scanning-related signal is not limited to the scan clock signal Gclk and the scan trigger signal Gstv that are described as examples, and may further include a reset clock signal Rclk (not shown in the figure), a reset signal Re, and a reference voltage signal (not shown in the figure). The reset clock signal Rclk and the reset signal Re are used to control the scanning drive circuit to accurately reset to an initial state, and the reference voltage signal is used to assist in controlling and driving the scanning drive circuit 13 to accurately output a scan signal. For example, the reference voltage signal may include a high potential voltage VGH and a low potential voltage VGL.

The data drive circuit 12 is connected to the time sequence control circuit 11, and is configured to receive, from the time sequence control circuit 11, the data clock signal (Dclk) and the data signal (Data) in the data-related signal. In addition, the data drive circuit 12 is connected to the m data lines in the display panel 10. The data drive circuit 12 transmits the data signal (Data) to the m data lines in a corresponding time sequence based on the received data clock signal (Dclk) and data signal (Data).

The storage unit 23 is configured to store first duration in which the first display area Aa performs image display in a display time period of each frame of image and second duration in which the second display area Ab performs image display. It may be understood that the first duration is duration in which a corresponding scan line in the first display area receives a scan signal to drive a pixel unit to perform image display, and the second duration is duration in which a corresponding scan line in the second display area receives a scan signal to drive a pixel unit to perform image display.

The detection circuit 24 is connected to the timing circuit 25. The detection circuit 24 is configured to detect a relative location relationship between the first display area Aa and the second display area Ab, that is, detect an angle between the first display area Aa and the second display area Ab. In other words, the detection circuit 24 detects whether the display apparatus 100 is in the folded state.

When the display apparatus 100 is in the unfolded state, the first display area Aa and the second display area Ab are located in the same plane, that is, the angle between the first display area Aa and the second display area Ab is 180°. When the display apparatus 100 is in the folded state, the first display area Aa and the second display area Ab are located in the different planes, that is, the angle between the first display area Aa and the second display area Ab is less than 180° or greater than 180°.

In this embodiment, the detection circuit 24 may be formed or implemented by a sensing circuit such as an angle sensor or a Hall effect sensor. The detection circuit 24 may be disposed in the display driver 20, or may be directly disposed in a foldable location of a corresponding display area of the display panel 10.

When the display apparatus 100 is in the unfolded state, that is, when the first display area Aa and the second display area Ab are located on the same display plane, both the first display area Aa and the second display area Ab perform image display, and the detection circuit 24 outputs a first detection signal, where the first detection signal indicates that the time sequence control circuit 11 needs to be controlled to continuously output a plurality of clock signals (Dclk, Gclk, Eclk), a scan trigger signal (Gstv), and a light-emitting trigger signal (Estv).

When the display apparatus 100 is the folded state, that is, when the first display area Aa and the second display area Ab are located in the different planes, the first display area Ab performs image display, the second display area Ab does not perform image display, and the detection circuit 24 outputs a second detection signal to the time sequence control circuit 11, where the second detection signal indicates that the time sequence control circuit 11 needs to be controlled to stop outputting a plurality of clock signals (Dclk, Gclk, Eclk), a scan trigger signal (Gstv), and a light-emitting trigger signal (Estv) in the second duration.

The timing circuit 25 is connected to the detection circuit 24. When the first display area and the second display area are located in the different planes, that is, when the timing circuit receives the first detection signal from the detection circuit 24, the timing circuit reads the first duration and the second duration from the storage unit 23, that is, performs timing on the first duration in which the pixel units 15 in the first row to the i^{th} row receive the data signal, and performs timing on the duration in which the pixel units 15 in the (i+1)^{th} row to the n^{th} row receive the data signal.

A first timing signal is output to the time sequence control circuit 11 when timing on the first duration is completed; and the time sequence control circuit 11 stops outputting the clock signal, the scan trigger signal, and the light-emitting trigger signal after receiving the first timing signal.

A second timing signal is output to the time sequence control circuit 11 when timing on the second duration is completed; and the time sequence control circuit 11 starts to output, for the first display area Aa, the clock signal, the scan trigger signal, and the light-emitting trigger signal in display duration of a frame of image after receiving the second timing signal. It may be understood that completing timing on the duration in which the pixel units in the (i+1)^{th} row to the n^{th} row receive the data signal indicates that a frame of image of the display apparatus 100 is displayed completely, and display of a next adjacent frame of image needs to be enabled.

The power supply circuit 26 is connected to the time sequence control circuit 11, the data drive circuit 12, the storage unit 23, the detection circuit 24, and the timing circuit 25, to provide a drive voltage required for the circuits to work.

It should be noted that this embodiment shows only a part of a circuit structure in the display driver 20. However, in actual implementation and application, the display driver 20 may set a corresponding functional circuit according to a requirement, and this is not limited thereto.

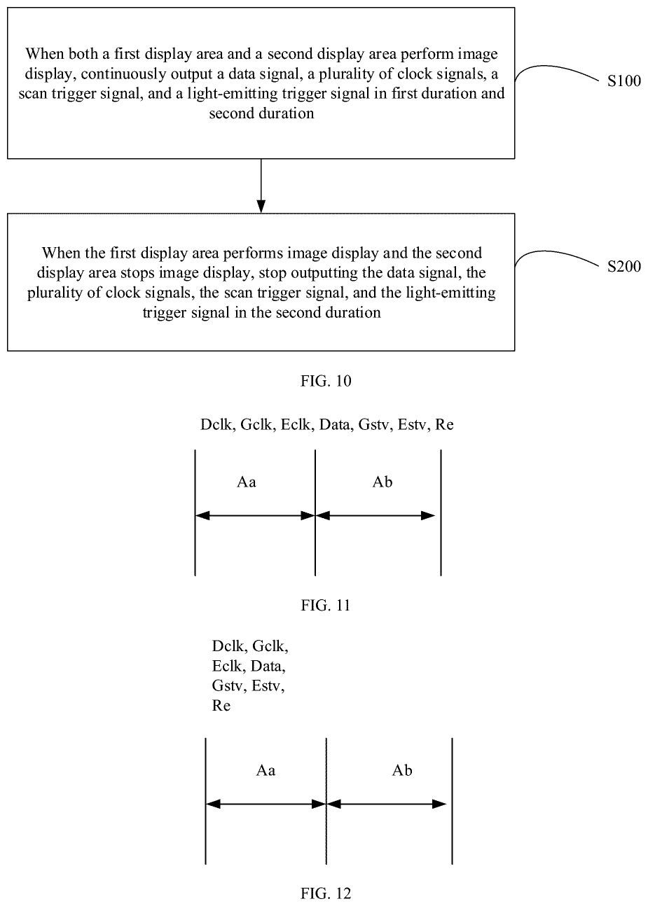

FIG. 10 is a flowchart of an image display driving method of the display apparatus 100 shown in FIG. 3 to FIG. 6. The display method of the display apparatus 100 is described in detail with reference to FIG. 3 to FIG. 10.

As shown in FIG. 10, the image display driving method includes the following steps.

Step S100: When both the first display area Aa and the second display area Ab perform image display, that is, when the display apparatus 100 is in an unfolded state, as shown in FIG. 11, in first duration and second duration, continuously output a scanning-related signal, a light-emitting-related signal, and a data-related signal, that is, continuously output a data signal (Data), a plurality of clock signals (Dclk, Gclk, Eclk), a scan trigger signal (Gstv), and a light-emitting trigger signal (Estv).

Step S200: When the first display area Aa performs image display and the second display area Ab stops image display, that is, when the display apparatus 100 is in an unfolded state, as shown in FIG. 12, in the second duration, stop outputting the scanning-related signal, the light-emitting-related signal, and the data-related signal, that is, stop outputting the data signal (Data), the plurality of clock signals (Dclk, Gclk, Eclk), the scan trigger signal (Gstv), and the light-emitting trigger signal (Estv). FIG. 11 and FIG. 12 each are a diagram of driving of the first display area Aa and the second display area Ab of the display panel shown in FIG. 6 and FIG. 7.

It may be understood that, before step S100, the method further includes a storage step, to store, in advance, the first duration in which a pixel unit in the first display area performs image display in display duration of a frame of image and the second duration in which a pixel unit in the second display area performs image display.

In the image display driving method performed by the display apparatus 100, before it is determined to output or stop outputting the scanning-related signal, the light-emitting-related signal, and the data-related signal, the method further includes a detection step, to detect a status of the display apparatus 100, that is, detect a location relationship between the first display area Aa and the second display area Ab by using the detection circuit 24.

When the location relationship between the first display area Aa and the second display area Ab is that the first display area Aa and the second display area Ab are located on a same display plane, the detection circuit 24 outputs a first detection signal to the time sequence control circuit 11 and the data drive circuit 12.

When the location relationship between the first display area Aa and the second display area Ab is that the first display area Aa and the second display area Ab are located on different display planes, the detection circuit 24 outputs a second detection signal.

The image display driving method performed by the display apparatus 100 further includes a timing step. The timing step specifically includes the following substeps:
when the second detection signal is received, performing timing on first duration in which the pixel units 15 in the first row to the i^{th} row receive the data signal (Data), and performing timing on duration in which the pixel units 15 in the (i+1)^{th} row to the n^{th} row receive the data signal (Data);
outputting a first timing signal to the time sequence control circuit 11 when timing on the first duration is completed, and stopping, by the time sequence control circuit 11, outputting the clock signal, the scan trigger signal, and the light-emitting trigger signal after receiving the first timing signal; and
outputting a second timing signal to the time sequence control circuit 11 when timing on the second duration is completed, and outputting, by the time sequence control circuit 11 for the first display area, a plurality of clock signals (Dclk, Gclk, Eclk), a scan trigger signal (Gstv), and a light-emitting trigger signal (Estv) in display duration of a frame of image after receiving the first timing signal.

Compared with the conventional technology, in the method, when the first display area Aa performs image display and the second display area Ab stops image display, in the second duration, the time sequence control circuit 11 stops outputting the scan clock signal (Gclk), the light-emitting clock signal (Eclk), the data clock signal (Dclk), the data signal (Data), the scan trigger signal (Gstv), and the light-emitting trigger signal (Estv), to stop outputting a plurality of drive signals when the second display area Ab does not perform image display. This effectively reduces power consumption corresponding to a case in which the second display area Ab does not perform image display.

The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A display driver configured to drive pixel units arranged in an array on a display panel comprising a first display area and a second display area to perform image display operations, the display driver comprising:
a time sequence control circuit configured to:
output a scanning-related signal, a data-related signal, and a light-emitting-related signal, wherein:
the scanning-related signal, the light-emitting-related signal, and the data-related signal are respectively configured to drive a scanning drive circuit in the display panel to output a scan signal, drive a light-emitting drive circuit in the display panel to output a light-emitting signal, and drive a data drive circuit to output a data signal to a plurality of pixel units, and
the scan signal, the light-emitting signal, and the data signal are configured to cooperate to drive the pixel unit to perform the image display operations,
in response to both the first display area and the second display area performing the image display operations, continuously output the scanning-related signal, the data-related signal, and the light-emitting-related signal in a first duration and a second duration; and
in response the first display area performing the image display operations and the second display area stopping the image display operations, stop outputting the scanning-related signal, the data-related signal, and the light-emitting-related signal in the second duration.

2. The display driver of claim 1, wherein:
the scanning-related signal comprises a scan clock signal, a scan trigger signal, and a reset signal;
the light-emitting-related signal comprises a light-emitting clock signal and a light-emitting trigger signal; and
the data-related signal comprises a data clock signal and the data signal, wherein
the scan clock signal and the scan trigger signal are configured to drive the scanning drive circuit to output the scan signal,
the light-emitting clock signal and the light-emitting trigger signal are configured to drive the light-emitting drive circuit to output the light-emitting signal, and
the data clock signal is configured to drive the data drive circuit to output the data signal.

3. The display driver of claim 2, further comprising a storage unit, the storage unit is configured to store the first duration and the second duration, wherein the first duration is a duration in which a pixel unit in the first display area performs the image display operations in a display duration of a frame of image, and the second duration is a duration in which a pixel unit in the second display area performs the image display operations.

4. The display driver of claim 3, further comprising a detection circuit configured to detect a relative location relationship between the first display area and the second display area, wherein:
in response to the first display area and the second display area being located in a same display plane, the pixel unit in the first display area and the pixel unit in the second display area are both configured to perform the image display operations, and the detection circuit is configured to output a first detection signal, wherein the first detection signal is configured to control the time sequence control circuit to continuously output the scanning-related signal, the data-related signal, and the light-emitting-related signal; and
in response to the first display area and the second display area being located in different planes, the pixel unit in the first display area is configured to perform the image display operations, the pixel unit in the second display area is configured not to perform the image display operations, and the detection circuit is configured to output a second detection signal to the time sequence control circuit, wherein the second detection signal is configured to control the time sequence control circuit to stop outputting the scanning-related signal, the data-related signal, and the light-emitting-related signal in the second duration.

5. The display driver of claim 4, wherein:
the display panel comprises a plurality of pixel units arranged in an n*m array, wherein the first display area comprises pixel units in a first row to an i^{th} row, and the second display area comprises pixel units in an (i+1)^{th} row to an n^{th} row, and i is a positive integer greater than or equal to 1 and less than n;
the first duration corresponds to a duration in which the pixel units in the first row to the i^{th} row receive the data signal; and
the second duration corresponds to a duration in which the pixel units in the (i+1)^{th} row to the n^{th} row receive the data signal.

6. The display driver of claim 5, further comprising a timing circuit connected to the detection circuit, wherein the timing circuit is configured to, in response to the first display area and the second display area being located in the different planes:
receive the first detection signal from the detection circuit;
perform timing on the first duration in which the pixel units in the first row to the i^{th} row receive the data signal;
perform timing on the duration in which the pixel units in the (i+1)^{th} row to the n^{th} row receive the data signal;
output a first timing signal to the time sequence control circuit in response to performing the timing on the first duration being completed, wherein the time sequence control circuit is configured to stop outputting the scanning-related signal, the data-related signal, and the light-emitting-related signal after receiving the first timing signal; and
output a second timing signal is output to the time sequence control circuit in response to performing the timing on the second duration being completed, wherein the time sequence control circuit is configured to output, for the first display area, the scanning-related signal, the data-related signal, and the light-emitting-related signal in a display duration of a frame of image after receiving the second timing signal.

7. A display panel, comprising the display driver of claim 2, and further comprising a display area and a non-display area, wherein:
the display area comprises n scan lines extending in a first direction, n light-emitting lines extending in the first direction, and m data lines extending in a second direction;
a plurality of pixel areas are formed at a location of intersection between the n scan lines and the m data lines, a plurality of pixel units are respectively correspondingly located in the pixel areas, and each pixel unit is connected to the scan lines, the light-emitting lines, and the data lines;
the first display area comprises pixel units correspondingly connected to a first scan line to an i^{th} scan line, and the second display area comprises pixel units correspondingly connected to an (i+1)^{th} scan line to an n^{th} scan line;
the scanning drive circuit and the light-emitting drive circuit are disposed in the non-display area;
the scanning drive circuit is connected to the n scan lines, the light-emitting drive circuit is connected to the n light-emitting lines, and the display driver is connected to the scanning drive circuit, the light-emitting drive circuit, and the m data lines extending in the second direction, to respectively provide the scanning-related signal, the data-related signal, and the light-emitting-related signal; and
the scanning drive circuit is configured to output the scan signal based on the scan clock signal and the scan trigger signal;
the scanning drive circuit is connected to the first scan line to the n^{th} scan line and is configured to sequentially output a plurality of scan signals;
the light-emitting drive circuit is configured to output the light-emitting signal based on the light-emitting clock signal and the light-emitting trigger signal; and
the light-emitting drive circuit is connected to a first light-emitting line to an n^{th} light-emitting line and is configured to sequentially output a plurality of light-emitting signals.

8. The display panel of claim 7, further comprising a storage unit, the storage unit is configured to store the first duration and the second duration, wherein the first duration is a duration in which a pixel unit in the first display area performs the image display operations in a display duration of a frame of image, and the second duration is a duration in which a pixel unit in the second display area performs the image display operations.

9. The display panel of claim 8, further comprising a detection circuit configured to detect a relative location relationship between the first display area and the second display area, wherein:
in response to the first display area and the second display area being located in a same display plane, the pixel unit in the first display area and the pixel unit in the second display area are both configured to perform the image display operations, and the detection circuit is configured to output a first detection signal, wherein the first detection signal is configured to control the time sequence control circuit to continuously output the scanning-related signal, the data-related signal, and the light-emitting-related signal; and
in response to the first display area and the second display area being located in different planes, the pixel unit in the first display area is configured to perform the image display operations, the pixel unit in the second display area is configured not to perform the image display operations, and the detection circuit is configured to output a second detection signal to the time sequence control circuit, wherein the second detection signal is configured to control the time sequence control circuit to stop outputting the scanning-related signal, the data-related signal, and the light-emitting-related signal in the second duration.

10. The display panel of claim 9, wherein:
the display panel comprises a plurality of pixel units arranged in an n*m array, wherein the first display area comprises pixel units in a first row to an i^{th} row, and the second display area comprises pixel units in an (i+1)^{th} row to an n^{th} row, and i is a positive integer greater than or equal to 1 and less than n;
the first duration corresponds to a duration in which the pixel units in the first row to the i^{th} row receive the data signal; and
the second duration corresponds to a duration in which the pixel units in the (i+1)^{th} row to the n^{th} row receive the data signal.

11. The display panel of claim 10, further comprising a timing circuit connected to the detection circuit, wherein the timing circuit is configured to, in response to the first display area and the second display area being located in the different planes:
receive the first detection signal from the detection circuit;
perform timing on the first duration in which the pixel units in the first row to the i^{th} row receive the data signal;
perform timing on the duration in which the pixel units in the (i+1)^{th} row to the n^{th} row receive the data signal;
output a first timing signal to the time sequence control circuit in response to performing the timing on the first duration being completed, wherein the time sequence control circuit is configured to stop outputting the scanning-related signal, the data-related signal, and the light-emitting-related signal after receiving the first timing signal; and
output a second timing signal is output to the time sequence control circuit in response to performing the timing on the second duration being completed, wherein the time sequence control circuit is configured to output, for the first display area, the scanning-related signal, the data-related signal, and the light-emitting-related signal in a display duration of a frame of image after receiving the second timing signal.

12. A method, applied to a display driver configured to drive pixel units arranged in an array on a display panel to perform image display, wherein the display panel comprises a first display area and a second display area, the method comprising:
in response to both the first display area and the second display area performing an image display operations, continuously outputting a scanning-related signal, a data-related signal, and a light-emitting-related signal in a first duration and a second duration; and
in response to the first display area performing the image display operations and the second display area stopping performing the image display operations, stopping outputting the scanning-related signal, the data-related signal, and the light-emitting-related signal in the second duration, wherein
the scanning-related signal, the light-emitting-related signal, and the data-related signal are respectively used to drive a scanning drive circuit in the display panel to output a scan signal, drive a light-emitting drive circuit in the display panel to output a light-emitting signal, and drive a data drive circuit to output a data signal to a plurality of pixel units,
the scan signal, the light-emitting signal, and the data signal cooperate to drive the pixel unit to perform image display,
the first duration is a duration in which a pixel unit in the first display area performs the image display operations in a display duration of a frame of image, and
the second duration is a duration in which a pixel unit in the second display area performs the image display operations.

13. The method of claim 12, wherein:
outputting the scanning-related signal, the data-related signal, and the light-emitting-related signal comprises controlling a time sequence control circuit to output the scanning-related signal, the data-related signal, and the light-emitting-related signal, wherein:
the scanning-related signal comprises a scan clock signal, a scan trigger signal, and a reset signal,
the light-emitting-related signal comprises a light-emitting clock signal and a light-emitting trigger signal,
the data-related signal comprises a data clock signal and the data signal,
the scan clock signal and the scan trigger signal are used to drive the scanning drive circuit to output the scan signal,
the light-emitting clock signal and the light-emitting trigger signal are used to drive the light-emitting drive circuit to output the light-emitting signal, and
the data clock signal is used to drive the data drive circuit to output the data signal; and
the method further comprises, after the time sequence control circuit outputs the data-related signal, controlling the data drive circuit to output the data signal to a plurality of data lines based on the data clock signal.

14. The method of claim 13, further comprising:
detecting a location relationship between the first display area and the second display area; and
in response to the first display area and the second display area being located in a same display plane, outputting a first detection signal to the time sequence control circuit, wherein the first detection signal is used to control the time sequence control circuit to continuously output the scanning-related signal, the data-related signal, and the light-emitting-related signal; and
in response to the first display area and the second display area being located in different display planes, outputting a second detection signal to the time sequence control circuit, wherein the second detection signal is used to control the time sequence control circuit to stop outputting the scanning-related signal, the data-related signal, and the light-emitting-related signal in the second duration.

15. The method of claim 14, further comprising controlling a timing circuit to perform timing on the first duration and the second duration, controlling the timing circuit comprising:
in response to the second detection signal being received, performing timing on the first duration in which pixel units in a first row to an i^{th} row receive the data signal, and performing timing on a duration in which pixel units in an (i+1)^{th} row to an n^{th} row receive the data signal;
outputting a first timing signal to the time sequence control circuit in response to performing the timing on the first duration being completed;
stopping, by the time sequence control circuit, outputting the scanning-related signal, the data-related signal, and the light-emitting-related signal after receiving the first timing signal;
outputting a second timing signal to the time sequence control circuit in response to performing the timing on the second duration being completed; and
outputting, by the time sequence control circuit for the first display area, the scanning-related signal, the data-related signal, and the light-emitting-related signal in a display duration of a frame of image after receiving the first timing signal.

16. The method of claim 15, further comprising:
storing the first duration and the second duration in a storage unit in advance, wherein:
the display panel comprises a display area and a non-display area, the display area comprises n scan lines extending in a first direction, n light-emitting lines extending in the first direction, and m data lines extending in a second direction, the first display area comprises pixel units correspondingly connected to a first scan line to an i^{th} scan line, the second display area comprises pixel units correspondingly connected to an (i+1)^{th} scan line to an n^{th} scan line, the first duration is a duration in which the first scan line to the i^{th} scan line output a plurality of scan signals, and the second duration is a duration in which the (i+1)^{th} scan line to the n^{th} scan lines output a plurality of scan signals,
disposing the scanning drive circuit and the light-emitting drive circuit in the non-display area, wherein the scanning drive circuit is connected to the n scan lines, and the light-emitting drive circuit is connected to the n light-emitting lines.

17. A method of operating a display driver configured to drive pixel units arranged in an array on a display panel comprising a first display area and a second display area to perform image display operations, the method comprising:
outputting, by a time sequence control circuit, a scanning-related signal, a data-related signal, and a light-emitting-related signal, wherein:
the scanning-related signal, the light-emitting-related signal, and the data-related signal are respectively used to drive a scanning drive circuit in the display panel to output a scan signal, drive a light-emitting drive circuit in the display panel to output a light-emitting signal, and drive a data drive circuit to output a data signal to a plurality of pixel units, and
the scan signal, the light-emitting signal, and the data signal cooperate to drive the pixel unit to perform the image display operations,
in response to both the first display area and the second display area performing the image display operations, continuously outputting the scanning-related signal, the data-related signal, and the light-emitting-related signal in a first duration and a second duration; and
in response the first display area performing the image display operations and the second display area stopping performing the image display operations, stopping outputting the scanning-related signal, the data-related signal, and the light-emitting-related signal in the second duration.

18. The method of claim 17, wherein:
the scanning-related signal comprises a scan clock signal, a scan trigger signal, and a reset signal;
the light-emitting-related signal comprises a light-emitting clock signal and a light-emitting trigger signal; and
the data-related signal comprises a data clock signal and the data signal, wherein
the scan clock signal and the scan trigger signal are configured to drive the scanning drive circuit to output the scan signal,
the light-emitting clock signal and the light-emitting trigger signal are configured to drive the light-emitting drive circuit to output the light-emitting signal, and
the data clock signal is configured to drive the data drive circuit to output the data signal.

19. The method of claim 18, further comprising storing the first duration and the second duration, wherein the first duration is a duration in which a pixel unit in the first display area performs the image display operations in a display duration of a frame of image, and the second duration is a duration in which a pixel unit in the second display area performs the image display operations.
